(19) United States
(12) Patent Application Publication
(10) Pub. No.: US 2003/0109377 A1
(43) Pub. Date: Jun. 12, 2003

(54) Catalyst composition and process for preparing olefin polymers

(75) Inventors: Shu-Hua Chan, Miaoli (TW); Ching Ting, Hsinchu (TW); Chung-Yuan Mou, Taipei (TW); Hong-Ping Lin, Taipei (TW)

Correspondence Address: SUGHRUE MION, PLLC, 2100 PENNSYLVANIA AVENUE, N.W., WASHINGTON, DC, 20037, US

(73) Assignee: INDUSTRIAL TECHNOLOGY RESEARCH INSTITUTE

(21) Appl. No.: 10/279,874

(22) Filed: Oct. 25, 2002

Related U.S. Application Data
(63) Continuation-in-part of application No. 09/987,756, filed on Nov. 15, 2001.

(51) Int. Cl. B01J 31/00

(52) U.S. Cl. 502/102; 502/103; 502/117; 502/118; 502/152; 502/153; 502/154; 502/232; 502/240; 502/263

(57) ABSTRACT

The present invention provides a catalyst composition and process for preparing olefin polymers. The catalyst composition includes a metallocene catalyst or a single-site catalyst, a mesoporous molecular sieve, and an aluminum-containing cocatalyst such as MAO. The cocatalyst is present in an amount such that the molar ratio of aluminum content in cocatalyst to the metal content in metallocene is from 0 to 200. When the catalyst composition is used for preparing polyolefins, the MAO amount can be decreased; thus, the production costs are greatly reduced.

### CROSS REFERENCE TO RELATED APPLICATIONS

This application is a continuation-in-part of application Ser. No. 09/987,756 filed on Nov. 15, 2001, now pending.

### BACKGROUND OF THE INVENTION

1. Field of the Invention

The present invention relates to a catalyst composition and process for preparing olefin polymers, and more particularly to a process for preparing an olefin polymer using a metallocene catalyst or single-site catalyst supported on an ordinary mesoporous molecular sieve or tubules-within-a-tubule type MCM-41. The cocatalyst amount can be decreased to an amount such that the molar ratio of aluminum content in cocatalyst to the metal content in metallocene is from 0 to 200.

2. Background of the Invention

Olefin-based polymers have been used in a wide range of applications. One group of commonly used olefin-based polymers is polyolefins, that is, homopolymers or copolymers of olefins. These polyolefin plastics are typically used in such applications such as blow and injection molding, extrusion coating, film and sheeting, pipe, wire and cable.

One generally applied method of preparation polyethylene is subjecting one or more olefin monomers to polymerization in the presence of a supported metallocene catalyst and methyl aluminoxane (MAO) (serving as a cocatalyst). The so-called supported metallocene is a metallocene supported on an inorganic carrier such as porous alumina, silica, or alumisilicate. In order to attain the desired catalytic activity for metallocene catalyst, the MAO amount must be high enough that the molar ratio of aluminum content in MAO to the center metal content in metallocene is higher than 200. This MAO amount inflates production costs.

Another polymerization system includes an organometallic catalyst such as a late transition metal single-site catalyst. They too require the use of methyl aluminoxane (MAO) to attend the desired activities. For example, in WO 96/23010, the single-site catalyst requires the presence of MAO as a cocatalyst to maintain desired catalyst activity.

### SUMMARY OF THE INVENTION

The object of the present invention is to provide a catalyst composition for preparing olefin polymers. By means of the catalyst composition, the MAO amount can be decreased to an amount such that the molar ratio of Al/Zr is from 0 to 200. Thus, production costs are greatly reduced.

To achieve the above-mentioned object, the catalyst composition of the present invention includes (a) a metallocene catalyst or a single-site catalyst; (b) a mesoporous molecular sieve; and (c) an aluminum-containing cocatalyst. The cocatalyst is present in an amount such that the molar ratio of aluminum content in cocatalyst to the metal content in metallocene is from 0 to 200.

### DETAILED DESCRIPTION OF THE INVENTION

The present invention provides a catalyst composition for preparing olefin polymers. The catalyst composition of the present invention includes: (a) a metallocene catalyst or a single-site catalyst; (b) a mesoporous molecular sieve; and (c) an aluminum-containing cocatalyst. The cocatalyst is present in an amount such that the molar ratio of aluminum content in cocatalyst to the metal content in metallocene is from 0 to 200.

The mesoporous molecular sieve suitable for use in the present invention can be an inorganic porous support material. Representative examples of the inorganic porous support typically include inorganic oxides of silica, silica-alumina, silica-thoria, silica-zirconia, clay, crystalline silicates, e.g., zeolites and silicoaluminophosphates (SAPOs) and comparable oxides which are porous, and have surface hydroxyl groups, viz., silanol groups. Other suitable inorganic porous support materials include titania, zirconia, alumina, vanadia and rare earth oxides which have surface hydroxyl groups. Silicoaluminophosphate of various structures are taught in U.S. Pat. No. 4,440,871.

A breakthrough toward the preparation of mesoporous molecular sieves have been disclosed recently in U.S. Pat. Nos. 5,098,684 and 5,102,643. The claimed class of mesoporous materials (denoted as M41S) of this prior art was found to possess uniform and adjustable pore size in the range of 1.3-10.0 nm. Morphology dependence on preparation condition of M41s materials to form hexagonal(MCM-41), cubic(MCM-48) or layered crystallographic structure (MCM-50) have been disclosed (Beck et al., J. Am. Chem. Soc., 114, 10834-10843; 1992).

Another type of mesoporous material used in the present invention relates to different method of synthesizing porous materials by using amphiphilic block copolymer as templates is shown in U.S. Pat. No. 6,054,111 and WO 99/37705. Polymeric liquid-crystal aggregates are used as templating agents for the synthesis of mesoporous materials, the pore size is adjustable simply by varying the length of the polymer template in the range from 3 to 50 nm.

The mesoporous molecular sieve suitable for use in the present invention can be an acidic crystalline material and preferably has a pore size of 2.0 to 50.0 nm and a surface area of at least 100 m²/g. The mesoporous molecular sieve can be a one-dimensional, two-dimensional, or three-dimensional material. A representative example of the one-dimensional molecular sieves is MCM-50. Representative examples of the two-dimensional molecular sieve include MCM-41 and SBA-15. A representative example of the three-dimensional molecular sieve is MCM-48.

MCM-41 suitable for use in the present invention can be ordinary MCM-41 (such as hexagonal-arranged), or can have tubules-within-a-tubule morphology. The present invention uses, for the first time, such tubules-within-a-tubule type MCM-41 mesoporous molecular sieve as a carrier to support the metallocene catalyst.

The above-mentioned MCM-41 with tubules-within-a-tubule morphology is referred to as TWT-MCM-41 and is synthesized by Mou in U.S. Pat. No. 5,876,690.

It is known that MCM-41 is a mesoporous molecular sieve having hexagonal tubules with a diameter of 1.5 to 10.0 nm. The morphology of Mou's mesoporous molecular sieve is different from conventional MCM-41 in its “tubules-within-a-tubule” hierarchical order morphology. The morphology of Mou's molecular sieve provides a better mass tranfer effect. Therefore, the present invention uses Mou's special tubules-within-a-tubule type MCM-41 mesoporous molecular sieve as a carrier to support a metallocene catalyst to prepare olefin polymers. The following examples of the present invention prove that using the TWT-MCM-41 mesoporous molecular sieve as a carrier, the cocatalyst MAO amount can be decreased compared to the condition using conventional silica as a carrier.

The Mou's TWT-MCM-41 has the following composition:

M_{n/q}(AlₐSi_{b}O_{c})

wherein M is one or more ions of hydrogen, ammonium, alkali metals and alkaline earth metals, n is the charge of the composition excluding the M expressed as oxide, q is the weighed molar average valence of M, a and b are molar fractions of Al and Si, respectively, a+b=1, b>0, and c is a number from 1 to 2.5. Mou's U.S. Pat. No. 5,876,690 is incorporated as a reference and detailed descriptions about Mou's TWT-MCM-41 are omitted here.

The TWT-MCM-41 mesoporous molecular sieve used in the present invention has a microstructure composed of microparticles having a hexagonal arrangement of uniformly-sized pores having a diameter of 1.3-100 nm and exhibiting a hexagonal electron diffraction pattern that can be indexed with a d₁₀₀ value greater than 1.8 nm.

A feature of the TWT-MCM-41 mesoporous silicate molecular sieve used in the present invention is that about 30-100% of the microparticles are in substantially tubular form. These substantially tubular microparticles have a diameter of 0.1-20 μm, and a wall including the above-mentioned hexagonal arranged coaxial uniformly-sized pores.

Preferably, the TWT-MCM-41 mesoporous molecular sieve has from 70 to 100% of the microparticles in the substantially tubular form, and the substantially tubular microparticles have a diameter of 0.02-5 μm and a length of 0.05-20 μm.

In the composition M_{n/q}(AlₐSi_{b}O_{c}) of the TWT-MCM-41 molecular sieve, M is preferably an alkali metal ion, for example, sodium ion.

The TWT-MCM-41 molecular sieve used in the present invention can be a pure silicate molecular sieve or an aluminosilicate molecular sieve. That is to say, in the composition M_{n/q}(AlₐSi_{b}O_{c}), b is larger than 0, but a can be 0. Preferably, the TWT-MCM-41 mesoporous molecular sieve has a SiO₂:Al₂O₃ molar ratio ranging from 1:0 to 1:0.2.

The metallocene catalyst used in the present invention can be a bis (unsubstituted or substituted cyclopentadienyl) metal compound or a mono (unsubstituted or substituted cyclopentadienyl) metal compound.

When the metallocene is a bis (unsubstituted or substituted cyclopentadienyl) metal compound, it can be a bridged metallocene represented by the formula R(Z) (Z)MeQₖ and an unbridged metallocene represented by the formula (Z) (Z)MeQₖ, wherein each Z is bound to Me and is the same or different and is a ligand selected from substituted or unsubstituted cyclopentadienyl, substituted or unsubstituted indenyl, substituted or unsubstituted tetrahydroindenyl, substituted or unsubstituted octahydrofluorenyl, substituted or unsubstituted benzofluorenyl, substituted or unsubstituted fluorenyl ligands, and alkyl substituted cyclopentadienyl derivatives; R is a structural bridge linking the Z's and Me is a metal selected from the group consisting of IVB, VB, and VIB metals of the Periodic Table, each Q is the same or different and is hydrogen, halogens, and organoradicals; k is a number sufficient to fill out the remaining valences of Me.

When Q is an organoradical, it can be alkyl, aryl, alkoxy, amino (—NH₂), alkylamino (such as —N(CH₃)₂), amido (—(C═O)NH₂), or alkylamido.

When the metallocene is a bridged bis (unsubstituted or substituted cyclopentadienyl) metal compound, representative examples, but not limiting, include

ethylene-1,2-bis(η⁵-1-indenyl)titanium dichloride, ethylene-1,2-bis(η⁵-1-indenyl)titanium dimethyl, ethylene-1,2-bis(η⁵-1-indenyl)hafnium dichloride, ethylene-1,2-bis(η⁵-1-indenyl)hafnium dimethyl, isopropylidene(η⁵-9-fluorenyl)(η⁵-1-cyclopentadienyl)zirconium dichloride, isopropylidene(η⁵-9-fluorenyl)(η⁵-1 -cyclopentadienyl)zirconium dimethyl, dimethylsilyl(η⁵-9-fluorenyl)(η⁵-1-cyclopentadienyl)zirconium dichloride, dimethylsilyl(η⁵-9-fluorenyl)(η⁵-1-cyclopentadienyl)zirconium dimethyl, propylenesilyl-bis(η⁵-cyclopentadienyl)zirconium dichloride, and propylenesilyl-bis(η⁵-cyclopentadienyl) bis(dimethylamino)zirconium.

When the metallocene is an unbridged bis (unsubstituted or substituted cyclopentadienyl) metal compound, representative examples include

bis(η⁵-cyclopentadienyl)zirconium dichloride, bis(η⁵-cyclopentadienyl)zirconium dimethyl, bis(η⁵-cyclopentadienyl)titanium dichloride, bis(η⁵-cyclopentadienyl)titanium dimethyl, bis(η⁵-cyclopentadienyl)hafnium dichloride, bis(η⁵-cyclopentadienyl)hafnium dimethyl, bis(pentamethyl-η⁵-cyclopentadienyl)zirconium dichloride, bis(pentamethyl-η⁵-cyclopentadienyl)zirconium dimethyl, bis(pentamethyl-η⁵-cyclopentadienyl)titanium dichloride, bis(pentamethyl-η⁵-cyclopentadienyl)titanium dimethyl, bis(pentamethyl-η⁵-cyclopentadienyl)hafnium dichloride, bis(pentamethyl-η⁵-cyclopentadienyl)hafnium dimethyl, bis(η⁵-1-indenyl)zirconium dichloride, and bis(η⁵-1-indenyl)zirconium dimethyl.

When the metallocene is a mono(unsubstituted or substituted cyclopentadienyl) metal compound, representative examples include

η⁵-cyclopentadienyltitanium trichloride, η⁵-cyclopentadienyltitanium trimethyl, (tert-butylamido)dimethyl(tetramethyl-η⁵-cyclopentadienyl)silanetitanium dichloride, (tert-butylamido)dimethyl(tetramethyl -η⁵-cyclopentadienyl)silanetitanium dimethyl, (tert-butylamido)dimethyl(tetramethyl-η⁵-cyclopentadienyl)silanezirconium dichloride, (tert-butylamido)dimethyl(tetramethyl-η⁵-cyclopentadienyl)silanezirconium dimethyl, (tert-butylamido)dimethyl(tetramethyl-η⁵-cyclopentadienyl)methanetitanium dichloride, (tert-butylamido)dimethyl(tetramethyl-η⁵-cyclopentadienyl)methanetitanium dimethyl, (tert-butylamido)dimethyl(tetramethyl-η⁵-cyclopentadienyl)methanezirconium dichloride, and (tert-butylamido)dimethyl(tetramethyl-η⁵-cyclopentadienyl)methanezirconium dimethyl.

The single-site catalyst used in the present invention can be an organometallic compound, such as a late transition metal organometallic compound, for example, an organonickel or an organopalldium compound. Preferably, the organic portion of the organometallic compound has a bidentate structure of formula (I) or formula (II) to produce a compound of formula (III) or formula (IV).

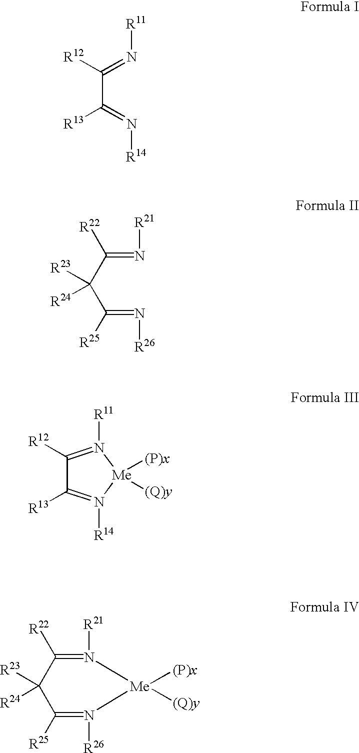

wherein

R¹¹, R¹⁴, R²¹, and R²⁶ are independently hydrocarbyl or substituted hydrocarbyl;

R¹² and R¹³ are independently hydrogen, hydrocarbyl, substituted hydrocarbyl or R¹² and R¹³ taken together are hydrocarbylene or substituted hydrocarbylene to form a ring;

R²², R²³, R²⁴, and R²⁵ are each independently hydrogen, hydrocarbyl, or substituted hydrocarbyl;

Me is Ti, Zr, Sc, V, Cr, a rare earth metal, or a Group VIII transition metal in the m oxidation state;

x and y are integers from 0 to 6, and x+y=m;

P is alkyl, hydride, chloride, bromide, or iodide; and

Q is alkyl, hydride, chloride, bromide, or iodide.

Preferably, Me is a Group VIII transition metal, and most preferably, Me is Fe, Co, Ni, or Pd.

Representative examples of single-site catalysts include 1,4-bis[2,6-diisopropylphenyl]-acenaphthene diimine-dichloronickel (see formula V), {2,6-C₆H₃(i-Pr₂)N═C(CH₃)CCH₃}═N{2,6-C₆H₃(i-Pr)₂}Pd(CH₃)Cl (see formula VI), and {2,6-C₆H₃(i-Pr₂)N═C(CH₃)CCH₃}═N{2,6-C₆H₃ (i-Pr)₂}NiBr₂.

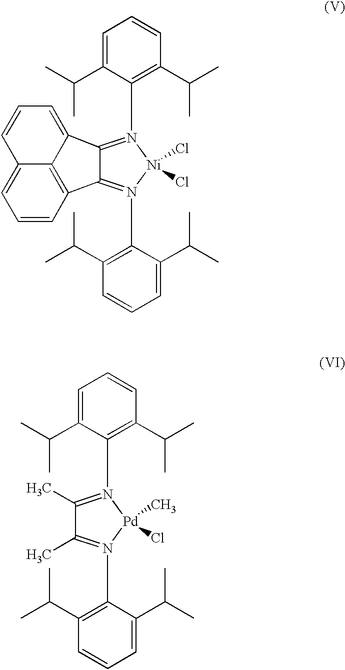

The aluminum-containing cocatlyst suitable for use in the present invention can be methyl aluminoxane, alkyl aluminoxane, trialkyl aluminum, dialkyl aluminum halide, an inert and non-coordinating anionic salt, or mixtures thereof. The trialkyl aluminum can be dimethyl ethyl aluminum (Me₂EtAl), trimethyl aluminum, triethyl aluminum, tripropyl aluminum, triisopropyl aluminum, tributyl aluminum, or triisobutylaluminum (TIBA).

Using the above-mentioned catalyst composition of the present invention, an olefin polymer can be synthesized. In the presence of a catalytically effective amount of the catalyst composition of the present invention under polymerizing conditions, an olefin can be polymerized or oligomerized (i.e., homopolymerized), or an olefin together with at least one monomer different from the olefin can be polymerized (i.e., copolymerized). The at least one monomer copolymerized may be or may not be of olefin type.

Suitable olefins include ethylene, propylene, butadiene, isoprene, and styrene. According to a preferred embodiment of the present invention, a novel type of polyethylene with high crystallinity (having a crystalline melting point higher than 137° C.) in low Mw range (in a weight molecular weight range less than 1,000,000) can be obtained.

Moreover, since the mesoporous molecular sieve of the present invention has a controllable pore size and uniform arrangement, it has space confining effect during polymerization. Therefore, it is suitable for preparing a structure regulated polymer or stereoselective polymer using the MCM-41 mesoporous molecular sieve as a carrier. Representive examples of such structure regulated polymers include high isotactic polypropylene, high cis polybutadiene, high cis polyisoprene, syndiotactic polystyrene, and a copolymer of a styrenic monomer and a diene.

The catalyst composition of the present invention can be used in slurry reaction conditions, gas phase, and solution polymerization reaction conditions. Polymerization is typically carried out at a temperature of 0° to 250° C., and an atmospheric pressure up to 3,000 psi.

The following examples are intended to illustrate the process and the advantages of the present invention more fully without limiting its scope, since numerous modifications and variations will be apparent to those skilled in the art.

### PRELIMINARY EXAMPLE 1

### Synthesis of Supports

### Tubules-Within-A-Tubule MCM-41 (TWT-MCM-41)(Si/Al=37)

6.85 g of C₁₆TMAB (cetyltrimethylammonium bromide) was dissolved in 37.5 g of water at 32° C. and stirred at 400 rpm. 0.1 g of NaAlO₂ (sodium aluminate) was dissolved in 5 g of water and then added to the above C₁6TMAB solution. 8.8 g of sodium silicate was added to the above mixed solution. 10.5 g of 1.20 M sulfuric acid aqueous solution was added by pipette very slowly in a total time of 30 minutes to cause gradual polymerization of sodium silicate. The pH of the final mixture was 10-9.

The gel solution formed was stirred for 20 minutes and then poured into a stainless steel autoclave. The gel solution was allowed to stand for 20 minutes and then heated at 100° C. for 48. hours. The solid product recovered by filtration was washed with deionized water two times, and then dried in ambient temperature or 100° C. to obtain an as-synthesized MCM-41 product.

The dried as-synthesized product was calcined at 560° C. in air for 6 hours to obtain the final tubules-within-a-tubule (TWT) MCM-41 product.

### PRELIMINARY EXAMPLE 2

### Particulate MCM-41 (Si/Al=37)

The same procedures as described in Example 1 were employed except that the amounts of water, C₁₆TMAB, NaAlO₂, and sodium silicate were changed, such that the H₂O/C₁₆TMAB molar ratio was controlled to about 178, and the Si/Al molar ratio was controlled to about 37. Thus, the obtained MCM-41 was in particulate morphology, which was different from the morphology of the MCM-41 obtained from Example 1.

### PRELIMINARY EXAMPLE 3

### Particulate Si-MCM-41 (No Al)

13.7 g of C₁₆TMAB (cetyltrimethylammonium bromide) was dissolved in 120 g of water at 32° C. 17.7 g of sodium silicate was added to the above C₁₆TMAB solution. 20.1 g of 1.20 M sulfuric acid aqueous solution was added to the above solution by pipette very slowly in a total time of 30 minutes to cause gradual polymerization of sodium silicate. The pH of the final mixture was 10˜9.

The gel solution formed was stirred for 20 minutes and then poured into a stainless steel autoclave. The gel solution was allowed to stand for 20 minutes and then heated at 100° C. for 48 hours. The solid product recovered by filtration was washed with deionized water two times, and then dried in ambient temperature or 100° C. to obtain an as-synthesized MCM-41 product.

The dried as-synthesized product was calcined at 560° C. in air at a heating rate of 1.5° C./min for 6 hours to remove the C₁₆TMAB template to obtain the final Si-MCM-41 product.

### PRELIMINARY EXAMPLE 4

### Particulate MCM-41 (Si/Al=15)

13.7 g of C₁₆TMAB was dissolved in 120 g of water at 32° C. 0.96 g of NaAlO₂ was dissolved in 10 g of water and then added to the above solution. 17.7 g of sodium silicate was added to the above C₁₆TMAB solution. 20.1 g of 1.20 M sulfuric acid aqueous solution was added to the above solution by pipette very slowly in a total time of 30 minutes to cause gradual polymerization of sodium silicate. The pH of the final mixture was 10˜9.

The gel solution formed was stirred for 20 minutes and then poured into a stainless steel autoclave. The gel solution was allowed to stand for 20 minutes and then heated at 100° C. for 48 hours. The solid product recovered by filtration was washed with deionized water two times, and then dried in ambient temperature or 100° C. to obtain an as-synthesized MCM-41 product.

The dried as-synthesized product was calcined at 560° C. in air at a heating rate of 1.5° C./min for 6 hours to remove the C₁₆TMAB template to obtain the final MCM-41 product.

### PRELIMINARY EXAMPLE 5

### Particulate MCM-41 (Si/Al=120)

13.7 9 of C₁₆TMAB was dissolved in 120 g of water at 32° C. 0.12 g of NaAlO₂ was dissolved in 10 g of water and then added to the above solution. 17.7 g of sodium silicate was added to the above C₁₆TMAB solution. 20.1 g of 1.20 M sulfuric acid aqueous solution was added to the above solution by pipette very slowly in a total time of 30 minutes to cause gradual polymerization of sodium silicate. The pH of the final mixture was 10˜9.

The gel solution formed was stirred for 20 minutes and then poured into a stainless steel autoclave. The gel solution was allowed to stand for 20 minutes and then heated at 100° C. for 48 hours. The solid product recovered by filtration was washed with deionized water two times, and then dried in ambient temperature or 100° C. to obtain an as-synthesized MCM-41 product.

The dried as-synthesized product was calcined at 560° C. in air at a heating rate of 1.5° C./min for 6 hours to remove the C₁₆TMAB template to obtain the final MCM-41 product.

### PRELIMINARY EXAMPLE 6

### MCM-48

NaAlO₂ (sodium aluminate), TEOS (tetraethylorthosilicate), NaOH, and TEAOH (tetraethylammonium hydroxide) (molar ratio=1:60.9:21.8:18.3) were mixed at 50° C. and stirred for 3 hours. The above solution was transferred into an autoclave and then placed in a 100° C. oven for 18 hours to obtain solution A. C₁₆TMAB was dissolved in water (C₁₆TMAB:H₂O=1:165 in molar ratio) and stirred at 50° C. to obtain solution B. Solution A was added to solution B and stirred for 1 hour. The mixed solution was transferred into an autoclave and then placed in a 150° C. oven for 24 hours.

The reaction mixture was evacuated and then filtered to obtain a crude solid product. After two washes with deionized water and filtration, the solid product was dried at room temperature or 100° C. to obtain an as-synthesized MCM-48 product (Si/Al=60).

The dried as-synthesized product was calcined at 560° C. in air for 6 hours to remove the C₁₆TMAB template to obtain the final MCM-48 product.

### EXAMPLE C1

### Preparation of Catalyst Composition

### TWT, Si/Al=37, No MAO was Added During Catalyst Preparation

A 100 ml reactor was dried in an oven for several hours. 1.0 g of the TWT-MCM-41 (Si/Al=37) obtained from Preliminary Example 1 and 30 ml of toluene were charged in the reactor in a dry box and stirred thoroughly. A Cp₂ZrCl₂ solution (0.19 g of Cp₂ZrCl₂ in 10 ml of toluene) was injected into the MCM-41 solution with a syringe and stirred at room temperature for 48 hours. After the reaction was complete, the reaction mixture was filtered and concentrated under reduced pressure to collect the solid catalyst.

### EXAMPLE C2

### TWT, Si/Al=37, MAO was Added During Catalyst Preparation

A 100 ml reactor was dried in an oven for several hours. 0.5 g of the TWT-MCM-41 obtained from Premilinary Example 1 and 30 ml of toluene were charged in the reactor in a dry box and stirred thoroughly. A Cp₂ZrCl₂ solution (0.1 g of Cp₂ZrCl₂ in 10 ml of toluene) was injected into the MCM-41 solution with a syringe and stirred at room temperature for 24 hours. Then, 15 ml of MAO (methyl aluminoxane) (1.4 M) was further added into the solution and stirred for another 24 hours. After the reaction was complete, the reaction mixture was filtered and concentrated under reduced pressure to collect the solid catalyst.

### EXAMPLE C3

### TWT, Si/Al=37, MAO was Added During Catalyst Preparation with Different Sequence

A 100 ml reactor was dried in an oven for several hours. 0.5 g of the TWT-MCM-41 obtained from Preliminary Example 1 and 30 ml of toluene were charged in the reactor in a dry box and stirred thoroughly. 15 ml of MAO (1.4 M) was added into the MCM-41 solution and stirred for 24 hours. Then, a Cp₂ZrCl₂ solution (0.1 g of Cp₂ZrCl₂ in 10 ml of toluene) was injected into the solution with a syringe and stirred at room temperature for another 24 hours. After the reaction was complete, the reaction mixture was filtered and concentrated under reduced pressure to collect the solid catalyst.

### EXAMPLE C4

### TWT, Si/Al=37, MAO was Added During Catalyst Preparation with Different Sequence

A 100 ml reactor was dried in an oven for several hours. 0.5 g of the TWT-MCM-41 obtained from Preliminary Example 1 and 30 ml of toluene were charged in the reactor in a dry box and stirred thoroughly. A Cp₂ZrCl₂ solution (0.1 g of Cp₂ZrCl₂ in 10 ml of toluene) and 15 ml of MAO (1.4 M) were previously mixed for 1 hour to give a metallocene solution. Then, the metallocene solution was injected into the MCM-41 solution with a syringe and stirred at room temperature for 48 hours. After the reaction was complete, the reaction mixture was filtered and concentrated under reduced pressure to collect the solid catalyst.

### EXAMPLE C5

### Catalyst Composition Containing MCM-48 (Si/Al=60)

A 100 ml reactor was dried in an oven for several hours. 1.0 g of the MCM-48 obtained from Preliminary Example 6 and 30 ml of toluene were charged in the reactor in a dry box and stirred thoroughly. A Cp₂ZrCl₂ solution (0.19 g of Cp₂ZrCl₂ in 10 ml of toluene) was injected into the MCM-48 solution with a syringe and stirred at room temperature for 48 hours. After the is reaction was complete, the reaction mixture was washed with toluene two times, filtered, and concentrated under reduced pressure to collect the solid catalyst.

### EXAMPLE C6

### Catalyst Composition Containing Amorphous SiO₂

A 100 ml reactor was dried in an oven for several hours. 0.5 g of amorphous SiO₂ (containing 15 wt % of aluminum, under a trademark of SMAO, purchased from Witco Co.) and 30 ml of toluene were charged in the reactor in a dry box and stirred thoroughly. A Cp₂ZrCl₂ solution (0.1 g of Cp₂ZrCl₂ in 10 ml of toluene) was injected into the SiO₂ solution with a syringe and stirred at room temperature for 48 hours. After the reaction was complete, the reaction mixture was filtered and concentrated under reduced pressure to collect the solid catalyst.

### EXAMPLE C7

### Catalyst Composition Containing Particulate MCM-41 (Si/Al=37)

A 100 ml reactor was dried in an oven for several hours. 0.5 g of the particulate MCM-41 (Si/Al=37) obtained from Preliminary Example 2 and 30 ml of toluene were charged in the reactor in a dry box and stirred thoroughly. A Cp₂ZrCl₂ solution (0.1 g of Cp₂ZrCl₂ in 10 ml of toluene) was injected into the MCM-41 solution with a syringe and stirred at room temperature for 48 hours. After the reaction was complete, the reaction mixture was filtered and concentrated under reduced pressure to collect the solid catalyst.

### EXAMPLE C8

### Catalyst Composition Containing Particulate MCM-41 (no Al)

A 100 ml reactor was dried in an oven for several hours. 1.0 g of Si-MCM-41 and 30 ml of toluene were charged in the reactor in a dry box and stirred thoroughly. A Cp₂ZrCl₂ solution (0.19 g of Cp₂ZrCl₂ in 10 ml of toluene) was injected into the MCM-41 solution with a syringe and stirred at room temperature for 48 hours. After the reaction was complete, the reaction mixture was filtered, washed with toluene two times, filtered, and concentrated under reduced pressure for 2 hours to collect the solid catalyst.

### EXAMPLE C9

### Catalyst Composition Containing Particulate MCM-41 (Si/Al=15)

A 100 ml reactor was dried in an oven for several hours. 1.0 g of MCM-41 (Si/Al=15) and 30 ml of toluene were charged in the reactor in a dry box and stirred thoroughly. A CP₂ZrCl₂ solution (0.19 g of Cp₂ZrCl₂ in 10 ml of toluene) was injected into the MCM-41 solution with a syringe and stirred at room temperature for 48 hours. After the reaction was complete, the reaction mixture was filtered, washed with toluene two times, filtered, and concentrated under reduced pressure for 2 hours to collect the solid catalyst.

### EXAMPLE C10

### Catalyst Composition Containing Particulate MCM-41 (Si/Al=120)

A 100 ml reactor was dried in an oven for several hours. 1.0 g of MCM-41 (Si/Al=120) and 30 ml of toluene were charged in the reactor in a dry box and stirred thoroughly. A Cp₂ZrCl₂ solution (0.19 g of Cp₂ZrCl₂ in 10 ml of toluene) was injected into the MCM-41 solution with a syringe and stirred at room temperature for 48 hours. After the reaction was complete, the reaction mixture was filtered, washed with toluene two times, filtered, and concentrated under reduced pressure for 2 hours to collect the solid catalyst.

### EXAMPLE C11

### TWT, Si/Al=37, No MAO was Added During Catalyst Preparation

A 100 ml reactor was dried in an oven for several hours. 0.25 g of the TWT-MCM-41 (Si/Al=37) obtained from Preliminary Example 1 and 20 ml of toluene were charged in the reactor in a dry box and stirred thoroughly. A Ni catalyst solution that contained 0.0225 g 1,4-bis[2,6-diisopropylphenyl]-acenaphthenediimine-dichloronickel Formula V) was injected into the MCM-41 solution with a syringe and stirred at room temperature for 48 hours. After the reaction was complete, the reaction mixture was filtered, washed with toluene twice, and concentrated under reduced pressure to collect the solid catalyst.

### COMPARATIVE EXAMPLE P1

### Synthesis of Polyolefin

### Polymerization Using Catalyst Supported on Amorphous Silica (Al/Zr=272)

The reactor vessel was heated to 80° C., evacuated for 1 hour, and introduced with nitrogen gas three times. 250 ml of toluene (water amount<10 ppm) was transferred into the reactor. 1 ml of TIBA (triisobutylaluminoxane) was charged into the reactor under nitrogen and stirred for 2 minutes and then 0.5 ml of MAO (1.49 M methyl aluminoxane) was charged. After the temperature was stabilized at 80° C., 16 mg of the catalyst composition prepared from Example C6 was charged and stirred. Then, ethylene was introduced into the reactor and the reaction mixture was stirred at 600 rpm.

After the reaction was complete (about 30 minutes) the solution was cooled and methanol was added to precipitate the product. The product was filtered and dried in a 50° C. oven for various tests. The results obtained are shown in Table 1.

### COMPARATIVE EXAMPLE P2

### Polymerization Using Homogeneous Catalyst (Al/Zr=931)

The reactor vessel was heated to 80° C., evacuated for 1 hour, and introduced with nitrogen gas three times. 250 ml of toluene (water amount<10 ppm) was transferred into the reactor. 1 ml of TIBA was charged into the reactor under nitrogen and stirred for 2 minutes and then 1 ml of MAO (1.49 M methyl aluminoxane) was charged. After the temperature was stabilized at 80° C., 1.6×10⁻⁶ mole of Cp₂ZrCl₂ (biscyclopentadienylzirconium dichloride) was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P1

### Polymerization (Al/Zr=164) Using Catalyst Supported on Particulate MCM-41 Support (Si/Al=37)

The reactor vessel was heated to 80° C., evacuated for 1 hour, and introduced with nitrogen gas three times. 250 ml of toluene (water amount<10 ppm) was transferred into the reactor. 1 ml of TIBA was charged into the reactor under nitrogen and stirred for 2 minutes and then 0.5 ml of MAO (1.49 M methyl aluminoxane) was charged. After the temperature was stabilized at 80° C., 16 mg of the catalyst composition prepared from Example C7 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P2

### Polymerization (Al/Zr=57) Using Catalyst Supported on TWT-MCM-41 Support (Si/Al=37)

The reactor vessel was heated to 80° C., evacuated for 1 hour, and introduced with nitrogen gas three times. 250 ml of toluene (water amount<10 ppm) was transferred into the reactor. 1 ml of TIBA was charged into the reactor under nitrogen and stirred for 2 minutes and then 0.5 ml of MAO (1.49 M methyl aluminoxane) was charged. After the temperature was stabilized at 80° C., 16 mg of the catalyst composition prepared from Example C1 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P3

### Polymerization (Al/Zr=126) Using Catalyst Supported on TWT-MCM-41 Support (Si/Al=37)

The reactor vessel was heated to 80° C., evacuated for 1 hour, and introduced with nitrogen gas three times. 250 ml of toluene (water amount<10 ppm) was transferred into the reactor. After the temperature was stabilized at 80° C., 16 mg of the catalyst composition prepared from Example C2 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P4

### Polymerization (Al/Zr=112) Using Catalyst Supported on TWT-MCM-41 Support (Si/Al=37)

The reactor vessel was heated to 80° C., evacuated for 1 hour, and introduced with nitrogen gas three times. 250 ml of toluene (water amount<10 ppm) was transferred into the reactor. After the temperature was stabilized at 80° C., 16 mg of the catalyst composition prepared from Example C3 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P5

### Polymerization (Al/Zr=156) Using Catalyst Supported on TWT-MCM-41 Support (Si/Al=37)

The reactor vessel was heated to 80° C., evacuated for 1 hour, and introduced with nitrogen gas three times. 250 ml of toluene (water amount<10 ppm) was transferred into the reactor. After the temperature was stabilized at 80° C., 16 mg of the catalyst composition prepared from Example C4 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P6

### Polymerization (Al/Zr=272) Using Catalyst Supported on MCM-48 Support (Si/Al=60)

The reactor vessel was heated to 80° C., evacuated for 1 hour, and introduced with nitrogen gas three times. 250 ml of toluene (water amount<10 ppm) was transferred into the reactor. 1 ml of 22.6 wt % TIBA was charged into the reactor under nitrogen and stirred for 2 minutes and then 0.5 ml of MAO (1.49 M methyl aluminoxane) was charged. After the temperature was stabilized at 80° C., 50 mg of the MCM-48 catalyst composition prepared from Example C5 was charged and stirred. Then, ethylene was introduced into the reactor and the reaction mixture was stirred at 600 rpm.

After the reaction was complete (about 60 minutes), the product was filtered and dried in a 50° C. oven for various tests. The results obtained are shown in Table 1.

### EXAMPLE P7

### Polymerization (Al/Zr=O) Using Catalyst Supported on MCM-48 Support (Si/Al=60)

The reactor vessel was heated to 80° C., evacuated for 1 hour, and introduced with nitrogen gas three times. 250 ml of toluene (water amount<10 ppm) was transferred into the reactor. 1 ml of 22.6 wt % TIBA was charged into the reactor under nitrogen and stirred for 2 minutes. After the temperature was stabilized at 80° C., 50 mg of the MCM-48 catalyst composition prepared from Example C5 was charged and stirred. Then, ethylene was introduced into the reactor and the reaction mixture was stirred at 600 rpm.

After the reaction was complete (about 60 minutes), the product was filtered and dried in a 50° C. oven for various tests. Tm analyzed by DSC was 144° C. The results obtained are shown in Table 1.

### EXAMPLE P8

### Polymerization (Al/Zr=0) Using Catalyst Supported on Particulate MCM-41 Support (Si/Al=120)

The reactor vessel was heated to 80° C., evacuated for 1 hour, and introduced with nitrogen gas three times. 250 ml of toluene (water amount<10 ppm) was transferred into the reactor. 1 ml of 22.6 wt % TIBA was charged into the reactor under nitrogen and stirred for 2 minute. After the temperature was stabilized at 80° C., 50 mg of the MCM-41 catalyst composition (Si/Al=120) prepared from Example C10 was charged and stirred. Then, ethylene was introduced into the reactor and the reaction mixture was stirred at 600 rpm.

After the reaction was complete (about 60 minutes) the product was filtered and dried in a 50° C. oven for various tests. The results obtained are shown in Table 1.

### EXAMPLE P9

### Polymerization (Al/Zr=0) Using Catalyst Supported on Particulate MCM-41 Support (Si/Al=37)

The reactor vessel was heated to 80° C., evacuated for 1 hour, and introduced with nitrogen gas three times. 250 ml of toluene (water amount<10 ppm) was transferred into the reactor. 1 ml of 22.6 wt % TIBA was charged into the reactor under nitrogen and stirred for 2 minutes. After the temperature was stabilized at 80° C., 50 mg of the MCM-41 catalyst composition (Si/Al=37) prepared from Example C7 was charged and stirred. Then, ethylene was introduced into the reactor and the reaction mixture was stirred at 600 rpm.

After the reaction was complete (about 60 minutes), the product was filtered and dried in a 50° C. oven for various tests. The results obtained are shown in Table 1.

### EXAMPLE P10

### Polymerization (Al/Zr=0) Using Catalyst Supported on Particulate MCM-41 Support (Si/Al=15)

The reactor vessel was heated to 80° C., evacuated for 1 hour, and introduced with nitrogen gas three times. 250 ml of toluene (water amount<10 ppm) was transferred into the reactor. 1 ml of 22.6 wt % TIBA was charged into the reactor under nitrogen and stirred for 2 minutes. After the temperature was stabilized at 80° C., 50 mg of the MCM-41 catalyst composition (Si/Al=15) prepared from Example C9 was charged and stirred. Then, ethylene was introduced into the reactor and the reaction mixture was stirred at 600 rpm.

After the reaction was complete (about 60 minutes), the product was filtered and dried in a 50 (C. oven for various tests. The results obtained are shown in Table 1.

TABLE 1

| | | | | | Catalytic | | |
|---|---|---|---|---|---|---|---|
| | | Si/Al | | | activity | | |
| | | of the | | Tm | (g PE/g | | |
| Example | Support | Support | Al/Zr | (° C.) | Zr · hr) | Mw | PDI |
| Comp. Ex. P1 | Amorphous SiO2 | | 272 | 140 | 4.97 × 104 | 175253 | 2.7 |
| Comp. Ex. P2 | None | | 931 | 137 | 8.3 × 104 | 102705 | 2.0 |
| Example P1 | Particulate | 37 | 164 | 140 | 1.48 × 104 | 169161 | 2.4 |
| | MCM-41, C9 | | | | | | |
| Example P2 | TWT-MCM-41, C1 | 37 | 57 | 142.4 | 7.3 × 104 | 150223 | 2.4 |
| Example P3 | TWT-MCM-41, C2 | 37 | 126 | 143 | 7.86 × 10⁴ | 156048 | 2.7 |
| Example P4 | TWT-MCM-41, C3 | 37 | 112 | 141.4 | 1.32 × 10⁵ | 134958 | 2.6 |
| Example P5 | TWT-MCM-41, C4 | 37 | 156 | 139 | 1.32 × 10⁵ | 184956 | 2.4 |
| Example P6 | MCM-48, C5 | 60 | 272 | 138 | 3.08 × 10⁴ | — | — |
| Example P7 | MCM-48, C5 | 60 | 0 | 141 | 2.26 × 10³ | — | — |
| Example P8 | Particulate | 120 | 0 | 143 | 9.26 × 10² | — | — |
| | MCM-41, C10 | | | | | | |
| Example P9 | Paticulate MCM- | 37 | 0 | 140 | 1.67 × 10³ | — | — |
| z | 41, C7 | | | | | | |
| Example P20 | Particulate | 15 | 0 | 141 | 2.24 ×10³ | — | — |
| | MCM-41, C9 | | | | | | |

### EXAMPLE P11

### Polymerization (Al/Zr=0) Using Ni Catalyst Supported on TWT-MCM-41 Support (Si/Al=37)

The reactor vessel was heated to 80° C., evacuated for 1 hour, and introduced with nitrogen gas three times. 200 ml of CH₂Cl₂ (water amount<10 ppm) was transferred into the reactor. 1 ml of 22.6 wt % TIBA was charged into the reactor under nitrogen and stirred for 2 minutes. After the temperature was stabilized at 30° C., 20 mg of the MCM-41 catalyst composition (Si/Al=37) prepared from Example C11 was charged and stirred. Then, 150 psi ethylene was introduced into the reactor and the reaction mixture was stirred at 600 rpm.

After the reaction was complete (about 60 minutes), methanol was added to the mixture to precipitate the polymer. The product was filtered and dried in a 50° C. oven for various tests. The results obtained are shown in Table 2.

TABLE 2

| | | | | | Catalytic |
|---|---|---|---|---|---|
| | | Si/Al | | | activity |
| | | of the | | Tm | (g PE/g |
| Example | Support | Support | Al/Ni | (° C.) | Zr × hr) |
| Example P11 | TWT-MCM-41, C11 | 37 | 0 | 87 | 4.97 × 10⁴ |

It can be seen from Table 1 and Table 2 that the present invention synthesizes olefin polymers successfully using decreased amount of MAO (Al/Zr molar ratio is lower than 200). Thus, the production cost is greatly decreased.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A catalyst composition comprising:
(a) a metallocene catalyst or a single-site catalyst;
(b) a mesoporous molecular sieve; and
(c) an aluminum-containing cocatalyst,
wherein the cocatalyst is present in an amount such that the molar ratio of aluminum content in cocatalyst to the metal content in metallocene is from 0 to 200.

2. The catalyst composition as claimed in claim 1, wherein the cocatalyst is present in an amount such that the molar ratio of aluminum content in cocatalyst to the metal content in metallocene is from 0 to 50.

3. The catalyst composition as claimed in claim 1, wherein the mesoporous molecular sieve is an acidic crystalline material.

4. The catalyst composition as claimed in claim 3, wherein the mesoporous molecular sieve has a pore size of 2.0 nm to 50.0 nm and a surface area of at least 100 m²/g.

5. The catalyst composition as claimed in claim 4, wherein the mesoporous molecular sieve is a one-dimensional material.

6. The catalyst composition as claimed in claim 5, wherein the mesoporous molecular sieve is MCM-50.

7. The catalyst composition as claimed in claim 4, wherein the mesoporous molecular sieve is a two-dimensional material.

8. The catalyst composition as claimed in claim 7, wherein the mesoporous molecular sieve is MCM-41.

9. The catalyst composition as claimed in claim 8, wherein the mesoporous molecular sieve is a hexagonal-arranged MCM-41.

10. The catalyst composition as claimed in claim 8, wherein the mesoporous molecular sieve is a MCM-41 material having tubules-within-a-tubule morphology and has the following composition:
M_{n/q}(AlₐSi_{b}O_{c})
wherein M is one or more ions of hydrogen, ammonium, alkali metals and alkaline earth metals;
n is the charge of the composition excluding the M expressed as oxide;
q is the weighted molar average valence of M;
a and b are molar fractions of Al and Si, respectively, a+b=1, b>0; and
c is a number from 1 to 2.5, the molecular sieve having a microstructure composed of microparticles having a hexagonal arrangement of uniformly-sized pores having a diameter of 1.3-20 nm and exhibiting a hexagonal electron diffraction pattern that can be indexed with a d₁₀₀ value greater than 1.8 nm, characterized in that about 30-100% of the microparticles are in substantially micrometer-scale tubular form, the substantially tubular microparticles have a diameter of 0.05-20 μm, and the substantially tubular microparticles have a wall comprising the hexagonal arranged coaxial uniformly-sized pores.

11. The catalyst composition as claimed in claim 10, wherein in the tubules-within-a-tubule MCM-41, 70-100% of the microparticles are in substantially micrometer-scale tubular form.

12. The catalyst composition as claimed in claim 10, wherein M is an alkali metal ion.

13. The catalyst composition as claimed in claim 12, wherein M is sodium ion.

14. The catalyst composition as claimed in claim 10, wherein the tubules-within-a-tubule MCM-41 has a SiO₂:Al₂O₃ molar ratio in the range between 1:0 and 1:0.2.

15. The catalyst composition as claimed in claim 7, wherein the mesoporous molecular sieve is SBA-15.

16. The catalyst composition as claimed in claim 4, wherein the mesoporous molecular sieve is a three-dimensional material.

17. The catalyst composition as claimed in claim 16, wherein the mesoporous molecular sieve is MCM-48.

18. The catalyst composition as claimed in claim 1, wherein the metallocene catalyst is a bis (unsubstituted or substituted cyclopentadienyl) metal compound or a mono (unsubstituted or substituted cyclopentadienyl) metal compound.

19. The catalyst composition as claimed in claim 18, wherein the metallocene catalyst is a bis (unsubstituted or substituted cyclopentadienyl) metal compound and is a bridged metallocene represented by the formula R(Z) (Z)MeQₖ or an unbridged metallocene represented by the formula (Z)(Z)MeQₖ,
wherein each Z is bound to Me and is the same or different and is a ligand selected from substituted or unsubstituted cyclopentadienyl, substituted or unsubstituted indenyl, substituted or unsubstituted tetrahydroindenyl, substituted or unsubstituted octahydrofluorenyl, substituted or unsubstituted benzofluorenyl, substituted or unsubstituted fluorenyl, and alkyl substituted cyclopentadienyl derivatives; R is a structural bridge linking the Z's and Me is a IVB, VB, or VIB metal on the Periodic Table, each Q is the same or different and is hydrogen, halogens, or organoradicals; and k is a number sufficient to fill out the remaining valences of Me.

20. The catalyst composition as claimed in claim 19, wherein the metallocene catalyst is the bridged metallocene represented by the formula R(Z) (Z)MeQₖ, and is
ethylene-1,2-bis(η⁵-1-indenyl)titanium dichloride, ethylene-1,2-bis(η⁵-1-indenyl)titanium dimethyl, ethylene-1,2-bis(η⁵-1-indenyl)hafnium dichloride, ethylene-1,2-bis(η⁵-1-indenyl)hafnium dimethyl, isopropylidene(η⁵-9-fluorenyl)(η⁵-1-cyclopentadienyl)zirconium dichloride, isopropylidene(η⁵-9-fluorenyl)(η⁵-1-cyclopentadienyl)zirconium dimethyl, dimethylsilyl(η⁵-9-fluorenyl)(η⁵-1-cyclopentadienyl)zirconium dichloride, dimethylsilyl (η⁵9-fluorenyl)(η⁵-1-cyclopentadienyl)zirconium dimethyl, propylenesilyl-bis (η⁵-cyclopentadienyl)zirconium dichloride, or propylenesilyl-bis(η⁵-cyclopentadienyl) bis(dimethylamino)zirconium.

21. The catalyst composition as claimed in claim 19, wherein the metallocene catalyst is the unbridged metallocene represented by the formula (Z)(Z)MeQₖ, and is
bis(η⁵-cyclopentadienyl)zirconium dichloride, bis(η⁵-cyclopentadienyl)zirconium dimethyl, bis(η⁵-cyclopentadienyl)titanium dichloride, bis(η⁵-cyclopentadienyl)titanium dimethyl, bis(η⁵-cyclopentadienyl)hafnium dichloride, bis(η⁵-cyclopentadienyl)hafnium dimethyl, bis(pentamethyl-η⁵-cyclopentadienyl)zirconium dichloride, bis(pentamethyl-η⁵-cyclopentadienyl)zirconium dimethyl, bis(pentamethyl-η⁵-cyclopentadienyl)titanium dichloride, bis(pentamethyl-η⁵-cyclopentadienyl)titanium dimethyl, bis(pentamethyl-η⁵-cyclopentadienyl)hafnium dichloride, bis(pentamethyl-η⁵-cyclopentadienyl)hafnium dimethyl, bis(η⁵-1-indenyl)zirconium dichloride, or bis(η⁵-1-indenyl)zirconium dimethyl.

22. The catalyst composition as claimed in claim 18, wherein the metallocene is a mono(unsubstituted or substituted cyclopentadienyl) metal compound and is
η⁵-cyclopentadienyltitanium trichloride, η⁵-cyclopentadienyltitanium trimethyl, (tert-butylamido)dimethyl(tetramethyl-η⁵-cyclopentadienyl)silanetitanium dichloride, (tert-butylamido)dimethyl(tetramethyl-η⁵-cyclopentadienyl)silanetitanium dimethyl, (tert-butylamido)dimethyl(tetramethyl-η⁵-cyclopentadienyl)silanezirconium dichloride, or (tert-butylamido)dimethyl(tetramethyl-η⁵-cyclopentadienyl)silanezirconium dimethyl.

23. The catalyst composition as claimed in claim 1, wherein the single-site catalyst is an organometallic compound.

24. The catalyst composition as claimed in claim 23, wherein the single-site catalyst has an organic portion having a bidentate structure of formula (I) or formula (II), 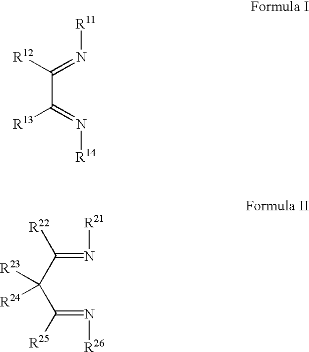
wherein:
R¹¹, R¹⁴, R²¹, and R²⁶ are independently hydrocarbyl or substituted hydrocarbyl;
R¹² and R¹³ are independently hydrogen, hydrocarbyl, substituted hydrocarbyl or R¹² and R¹³ taken together are hydrocarbylene or substituted hydrocarbylene to form a ring; and
R²², R²³, R²⁴, and R²⁵ are each independently hydrogen, hydrocarbyl, or substituted hydrocarbyl.

25. The catalyst composition as claimed in claim 24, wherein the single-site catalyst has the structure of formula (III) or formula (IV): 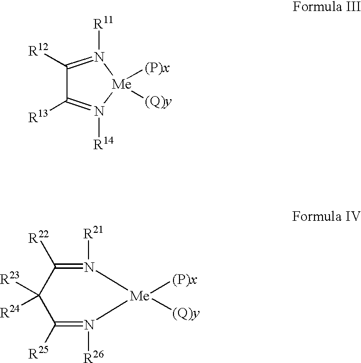
wherein:
R¹¹, R¹⁴, R²¹, and R²⁶ are independently hydrocarbyl or substituted hydrocarbyl;
R¹² and R¹³ are independently hydrogen, hydrocarbyl, substituted hydrocarbyl or R¹² and R¹³ taken together are hydrocarbylene or substituted hydrocarbylene to form a ring;
R²², R²³, R²⁴, and R²⁵ are each independently hydrogen, hydrocarbyl, or substituted hydrocarbyl;
Me is Ti, Zr, Sc, V, Cr, a rare earth metal, or a Group VIII transition metal in the m oxidation state;
x and y are integers from 0 to 6, and x+y=m;
P is alkyl, hydride, chloride, bromide, or iodide; and
Q is alkyl, hydride, chloride, bromide, or iodide.

26. The catalyst composition as claimed in claim 25, wherein Me is a Group VIII transition metal.

27. The catalyst composition as claimed in claim 26, wherein Me is Fe, Co, Ni, or Pd.

28. A process for preparing an olefin polymer, comprising the following steps:
(1) polymerizing an olefin, or (2) copolymerizing an olefin with at least one monomer different from the olefin, under polymerizing conditions in the presence of a catalytically effective amount of a catalyst composition as claimed in claim 1.

29. The process as claimed in claim 28, wherein the process comprises polymerizing an olefin and the olefin is ethylene.

30. The process as claimed in claim 29, wherein the olefin polymer obtained is polyethylene having a crystalline melting point higher than 137° C.

31. The process as claimed in claim 29, wherein the olefin polymer obtained is polyethylene, and wherein in the weight average molecular weight range of less than 1,000,000, the polyethylene has a crystalline melting point higher than 137° C.

32. The process as claimed in claim 28, wherein the process comprises polymerizing an olefin and the olefin is propylene, and wherein the olefin polymer obtained is high isotactic polypropylene.

33. The process as claimed in claim 28, wherein the process comprises polymerizing an olefin and the olefin is butadiene, and wherein the olefin polymer obtained is high cis polybutadiene.

34. The process as claimed in claim 28, wherein the process comprises polymerizing an olefin and the olefin is isoprene, and wherein the olefin polymer obtained is high cis polyisoprene.
